(19) United States
(12) Patent Application Publication
(10) Pub. No.: US 2020/0301332 A1
(43) Pub. Date: Sep. 24, 2020

(54) IMAGE-FORMING APPARATUS AND IMAGE-FORMING

(71) Applicant: Konica Minolta, Inc., Tokyo (JP)

(72) Inventor: Kazuhiko IMANISHI, Hino-shi, Tokyo (JP)

(21) Appl. No.: 16/087,906

(22) PCT Filed: Mar. 27, 2017
(86) PCT No.: PCT/JP2017/012341

§ 371 Date: Sep. 24, 2018

(30) Foreign Application Priority Data
Apr. 21, 2016 (JP) 2016-084886

(51) Int. Cl. G03G 15/00; G03G 15/24

(52) U.S. Cl. CPC G03G 15/505; G03G 15/24

(57) ABSTRACT

An image-forming apparatus contains a hardware processor for forming first and second reference marks on both surfaces of a first recording medium by using respective recorder. The first reference mark includes scale marks indicating coordinates in a position range relative to a first image-forming area, and the second reference mark includes an indicator indicating a position relative to a second image-forming area. The indicator is formed in a position indicating the relative position range as seen from a direction perpendicular to the surface of the recording medium. The hardware processor is also for implementing settings for adjusting the recording action of the recorder so that positional misalignment of the first and second image-forming areas diminishes based on coordinates inputted by an input section and indicated by the indicator. The hardware processor causes respective adjusted ordinary images to be formed on both surfaces of a second recording medium by the recorder.

### TECHNOLOGICAL FIELD

The present invention relates to an image-forming apparatus and an image-forming method.

### DESCRIPTION OF THE RELATED ART

Conventionally, there has been an image-forming apparatus which forms an image by giving and fixing the color material such as the ink and the toner on the recording medium. When an image is being formed on the other surface after an image is formed on one surface of the recoding medium by such image-forming apparatus, since the recording medium could be misaligned from an appropriate position, or the part where the color material is placed in the recording medium could shrink so as to deform the recording medium, and an unintended positional misalignment of the image-forming region may occur on both surfaces of the recording medium.

With respect to it, there is a technique to suppress the positional misalignment of the image-forming region on two surfaces of the recording medium by detecting the position and the deformation amount of the recording medium which has the image formed on one surface, and adjusting the image-forming region of the other surface according to the detection result. For example, in Patent Document 1, the technique providing a detection means detecting a predetermined reference mark formed on the recording medium, specifying the position and the deformation amount of the recording medium which has an image formed on one surface by detecting the position of the reference mark formed on the one surface of the recording medium by the detection means, and adjusting the positon and/or the size of the image being formed on the other surface of the recording medium according to the specified position and the deformation amount, is disclosed.

### PRIOR ART DOCUMENT

### Patent Document

### Patent Document 1: JP 2010-12757 A

### SUMMARY

### Problems to be Solved by the Invention

However, by providing the detection means of the positional misalignment or the deformation amount on the image-forming apparatus, there are problems that the configuration and the process become complicated, leading to the raise of the cost. On the other hand, it is not easy to specify the accurate misalignment amount and misalignment direction of the reference mark of the recording medium by sight without providing a detection means, therefore, there is a problem that it is not easy to appropriately suppress the positional misalignment of the recording region of an image in the front and the back surfaces of the recording medium.

An object of the present invention is to provide an image-forming apparatus and an image-forming method which can easily and appropriately suppress the positional misalignment of the image-forming region on the front and the back surfaces of the recording medium by a simple configuration.

### Means for Solving the Problem

In order to achieve the above object, the invention of an image-forming apparatus described in claim 1 includes: a recording means to perform recording operation to give a color material to a recording medium which allows a portion of an incident light to penetrate, an image-forming control means to cause the recording means to perform the recording operation and form each image on one surface and the other surface opposite to the one surface of the recording medium, an adjustment means to perform a setting up for adjusting of the image caused to be formed by the recording operation of the recording means by the image-forming control means, and an input means to accept input operation from external, wherein the image-forming control means causes the recording means to form a first reference mark on the one surface of a first recording medium, and causes the recording means to form a second reference mark on the other surface of the first recording medium, the first reference mark includes a scale indicating a coordinate corresponding to a relative position in a range of the relative position which is determined in advance in relation to a first image-forming region where a normal image which is a formation target is formed on the one surface, the second reference mark includes an indicator indicating a predetermined relative position in relation to a second image-forming region where the normal image is formed on the other surface, and the second reference mark is formed so that the position indicated by the indicator is in the range of the relative position which is determined in advance according to the scale of the first reference mark when the second reference mark is seen from a perpendicular direction to the one surface of the first recording medium, the input means accepts an input operation of a coordinate which is read from the scale in the position indicated by the indicator, the adjustment means performs a setting up for an adjustment of the recording operation by the recording means so as to reduce a positional misalignment of the first image-forming region and the second image-forming region on both surfaces of a recording medium based on the coordinate input by the input means, and the image-forming control means causes the recording means to form each adjusted normal image on the one surface and the other surface of a second recording medium which differs from the first recording medium based on the setting up for the adjustment by the adjustment means.

In the invention described in claim 2, in the image-forming apparatus according to claim 1, the image-forming control means causes the recording means to form either one of the first reference mark or the second reference mark, and the normal image on at least a surface where an image is formed earlier among the one surface and the other surface of the first recording medium.

In the invention described in claim 3, in the image-forming apparatus according to claim 1 or 2, the adjustment means performs the setting up for the adjustment of the recording operation by correcting at least either one of image data for a normal image formed on the one surface of the second recording medium and image data for a normal image formed on the other surface of the second recording medium.

In the invention described in claim 4, the image-forming apparatus according to any one of claims 1 to 3 includes a moving means to relative move the recording means and a recording medium in a first direction, the image-forming control means causes the recording means to form the normal image, the first reference mark and the second reference mark on the recording medium which relative moves, and the adjustment means performs a setting up for an adjustment of the recording operation in the first direction by correcting a giving timing of the color material onto the recording medium by the recording means.

In the invention described in claim 5, the image-forming apparatus according to any one of claims 1 to 4 includes a moving means to relative move the recording means and a recording medium in a first direction, the image-forming control means causes the recording means to form the normal image, the first reference mark and the second reference mark on the recording medium which relative moves, and components of a coordinate indicated by the scale respectively indicate a position in the first direction and a position in a second direction which is orthogonal to the first direction on the first recording medium.

In the invention described in claim 6, in the image-forming apparatus according to any one of claims 1 to 5, the image-forming control means at least causes the recording means to form the first reference mark and the second reference mark in vicinity of each of opposite vertexes of a pair on the first recording medium which is rectangular.

In the invention described in claim 7, in the image-forming apparatus according to claim 6, wherein the image-forming control means causes the recording means to form the first reference mark and the second reference mark in vicinity of each of four vertexes on the first recording medium.

In the invention described in claim 8, in the image-forming apparatus according to any one of claims 1 to 7, the second reference mark is formed in a position on the first recording medium where the indicator indicates a coordinate of a predetermined criterion point of the first reference mark when the second reference mark is seen from the perpendicular direction to the one surface of the first recording medium in a case where the normal image of the formation target is formed in the first image-forming region and the second image-forming region of the first recording medium as originally set up, and

the adjustment means performs the setting up for the adjustment of the recording operation based on a difference between the input coordinate and the coordinate of the criterion point.

In the invention described in claim 9, in the image-forming apparatus according to claim 8, the image-forming control means causes the recording means to form a plurality of the first reference marks on the one surface of the first recording medium, and form a plurality of the second reference marks corresponding to the plurality of the first reference marks on the other surface of the first recording medium, and the adjustment means performs the setting up for adjustment to adjust the difference for one predetermined reference mark pair among the plurality of reference mark pairs to zero by parallel moving at least either one of the first image-forming region and the second image-forming region based on a plurality of the differences for the plurality of the reference mark pairs each of which is made by a combination of the first reference mark formed on the first recording medium and the second reference mark corresponding to the first reference mark, and to adjust the difference for the reference mark pair other than the one predetermined reference mark pair to zero by deforming at least one of the first image-forming region and the second image-forming region.

In the invention described in claim 10, in the image-forming apparatus according to claim 9, the one predetermined reference mark pair is selected from the reference mark pair including the first reference mark which is closest to a formation starting position of the normal image in either one of the first image-forming region and the second image-forming region, where the normal image is formed earlier on the second recording medium.

In the invention described in claim 11, in the image-forming apparatus according to any one of claims 1 to 10, the first reference mark includes a scale value of the scale.

In order to achieve the above object, an image-forming method by an image-forming apparatus that includes: a recording means to perform recording operation to give a color material to a recording medium which allows a portion of an incident light to penetrate; and an input means to accept input operation from external, and that forms each image on one surface and the other surface opposite to the one surface of the recording medium by the recording operation of the recording means and performs a setting up for adjusting of the image caused to be formed by the recording operation of the recording means, includes: a reference mark forming step of causing the recording means to form a first reference mark on the one surface of a first recording medium, and causing the recording means to form a second reference mark on the other surface of the first recording medium, the first reference mark includes a scale indicating a coordinate corresponding to a relative position in a range of the relative position which is determined in advance in relation to a first image-forming region where a normal image which is a formation target is formed on the one surface, the second reference mark includes an indicator indicating a predetermined relative position in relation to a second image-forming region where the normal image is formed on the other surface, and the second reference mark is formed so that the position indicated by the indicator is in the range of the relative position which is determined in advance according to the scale of the first reference mark when the second reference mark is seen from a perpendicular direction to the one surface of the first recording medium, and the image-forming method includes: an input step of accepting, with the input means, an input operation of a coordinate which is read from the scale in the position indicated by the indicator, an adjustment step of performing a setting up for an adjustment of the recording operation by the recording means so as to reduce a positional misalignment of the first image-forming region and the second image-forming region on both surfaces of a recording medium based on the coordinate input by the input means; and a normal image forming step of causing the recording means to form each adjusted normal image on the one surface and the other surface of a second recording medium which differs from the first recording medium based on the setting up for the adjustment by the adjustment step.

### Advantageous Effects of Invention

By following the present invention, there is an effect that by a simple configuration, the suppression of the positional misalignment of the image-forming region on the front and the back surfaces of the recording medium could be made easily and appropriately.

### BRIEF DESCRIPTION OF THE DRAWINGS

FIG. 1 This is a figure showing the configuration outline of an inkjet recording device.

FIG. 2 This is a block diagram showing the main function configuration of an inkjet recording device.

FIG. 3A This is a figure showing an example of a scale image formed on the front surface of the recording medium.

FIG. 3B This is a figure showing an example of a reference marker formed on the back surface of the recording medium.

FIG. 3C This is a figure showing the condition of the reference marker on the back surface which is seen through and observed from the front surface.

FIG. 4 This is a figure showing the enlarged vicinity of each of the vertex of the recording medium in which the scale image and the reference marker are formed on.

FIG. 5 This is a flowchart showing the control order of the image-forming process.

FIG. 6A This is a figure showing an example of the scale image and the reference marker according to the modification example.

FIG. 6B This is a figure showing an example of the scale image and the reference marker according to the modification example.

### DETAILED DESCRIPTION OF EMBODIMENTS

Hereinafter, an embodiment according to image-forming apparatus and image-forming method of the present invention will be described on the basis of the drawings.

FIG. 1 is a figure showing the configuration outline of an inkjet recording device 1 (image-forming apparatus) in the embodiment of the present invention.

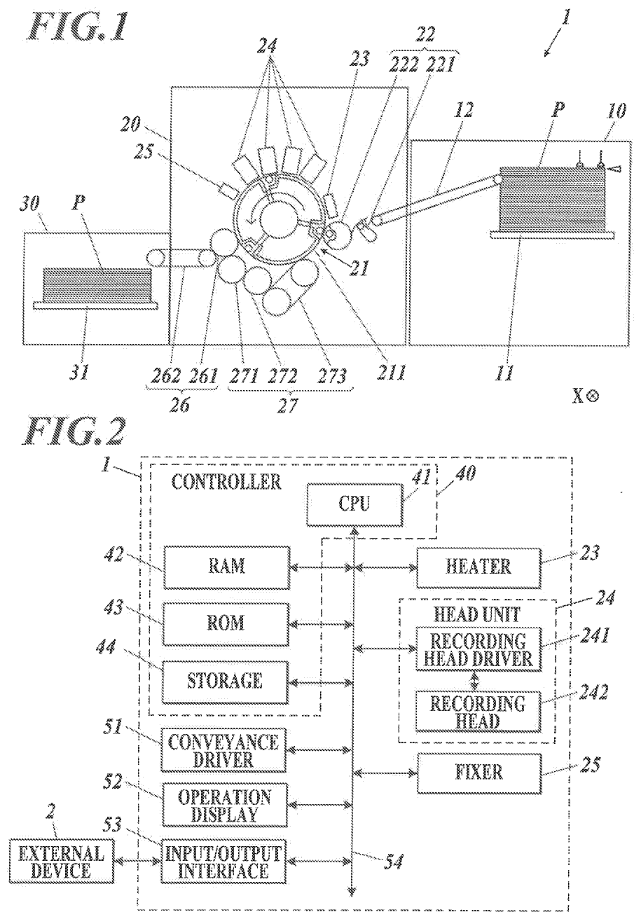

The inkjet recording device 1 includes a paper supplier 10, an image former 20, a medium ejector 30, and a controller 40 (FIG. 2). Under the control by the controller 40, the inkjet recording device 1 conveys the recording medium P stored in the paper supplier 10 to the image former 20, records an image on the recording medium P at the image former 20, and conveys the recording medium P on which an image was recorded to the medium ejector 30. In the embodiment, a recording medium P which has thickness or a material which is possible to allow a portion of the incident light to penetrate, and for which when one surface (below, written as the front surface) is observed by holding the light source over the one surface, the shape of the image formed on the other surface which is the opposite surface from the said one surface (below, written as the back surface) is able to be seen, is used as the recording medium P. As for the recording medium P, besides papers such as plain paper and coated paper, various mediums such as cloth and plate-like plastic which could fix the ink landed on the surfaces, are used.

The paper supplier 10 includes a paper feeding tray 11 which stores the recording medium P, and a medium supplier 12 which conveys and supplies the recording medium P to the image former 20 from the paper feeding tray 11. The medium supplier 12 includes a ring-like belt supported by two rollers inside, and by rotating the rollers under the state which the recording medium P is mounted on this belt, the recording medium P is conveyed to the image former 20 from the paper feeding tray 11.

The image former 20 includes a conveyer 21 (moving means), delivery unit 22, heater 23, head unit 24 (recording means), fixer 25, delivery section 26, reverser 27 and the like.

The conveyer 21 holds the recording medium P mounted on the conveying surface of the cylinder-like conveyance drum 211, and by the conveyance drum 211 rotating around and moving on the axis of the rotary shaft (cylinder shaft) extended in the perpendicular direction (X direction) to the figure in FIG. 1, the conveyance drum 211 and the recording medium P on the conveyance drum 211 are conveyed in the conveyance direction (Y direction) (the first direction). The conveyance drum 211 includes the claw and the intaker abbreviated in the figure to hold the recording medium P on the conveyance surface. The recording medium P is held on the conveyance surface by being kept on the edge by the claw, and also by being absorbed on the conveyance surface by the intaker. The conveyer 21 is connected to a conveyance drum motor abbreviated in the figure, to rotate the conveyance drum 211 and the conveyance drum rotates in the angle proportional to the rotating amount of the conveyance drum motor.

The delivery unit 22 delivers the recording medium P conveyed from the medium supplier 12 of the paper supplier 10, to the conveyer 21. The delivery unit 22 is provided in the position between the medium supplier 12 of the paper supplier 10 and the conveyer 21, holds and picks up the edge of the recording medium P conveyed from the medium supplier 12 by the swing arm section 221 and gives it to the conveyer 21 through the delivery drum 222.

The heater 23 is provided between the arrangement position of the delivery drum 222 and the arrangement position of the head unit 24, and heats the recording medium P so that the recording medium P which is conveyed from the conveyer 21 is heated to a temperature within the predetermined temperature range. The heater 23 includes an infrared ray heater and the like for example, and heats the infrared ray heater by conducting electricity to the infrared ray heater based on the control signal supplied from the CPU 41 (FIG. 2).

The head unit 24 forms an image on the recording medium P by performing a recording operation which is the discharging of an ink (color material) towards the recording medium P from the nozzle opening provided on the ink discharging surface facing the conveyance surface of the conveyance drum 211, at an appropriate timing according to the rotation of the conveyance drum 211 which the recording medium P is being held. The head unit 24 is arranged so that the ink discharging surface and the conveyance surface will be separated for a predetermined distance. In the inkjet recording device 1 of the embodiment, four head units 24 which respectively correspond to four colors of ink such as yellow (Y), magenta (M), cyan (C), black (K) are arranged so as to array with a predetermined interval in the color orders of Y, M, C, K from the upstream side of the conveyance direction of the recording medium P.

Each head unit 24 includes plurality of (for example, four) recording heads 242 (FIG. 2) which respectively arrays in the direction which plurality of recording elements crosses with the conveyance direction of the recording medium P (in the embodiment, the width direction orthogonal to the conveyance direction (the second direction)), which is the X direction, and the recording head driver 241 (FIG. 2) which drives the recording head 242.

Each of the recording elements provided in the recording head 242 includes a pressure chamber which stores an ink, a piezoelectric element which is provided on the wall surface of the pressure chamber, and a nozzle. This recording element discharges an ink from the nozzle communicating with the pressure chamber when the driving signal which makes the deformation operation of the piezoelectric element is input, and the pressure inside the pressure chamber changes due to the deformation of the pressure chamber by the deformation of the piezoelectric element.

The plurality of recording heads 242 on the head unit 24 is arranged with the X direction slightly moved (typically in a zig-zag pattern), so the arrangement range of the X direction of the recording elements included in the plurality of recording head 242 covers the width of the X direction in the image recording region of the recording medium P which is to be conveyed by the conveyance drum 211. Further, in the time of recording the image, the position of the head unit 24 is fixed in relation to the conveyance drum 211 and used. That is, the inkjet recording device 1 is an inkjet recording device which performs image recording by a single pass manner using a line head.

As for the ink discharged from the nozzle of the recording element, inks which have properties having the phase-change to gel-like or sol-like due to the temperature and hardening due to the emission of an energy ray such as the ultraviolet ray, are used.

Further, in the embodiment, the ink which is gel-like at the normal temperature and becomes sol-like when heated, is used. The head unit 24 includes an ink heater abbreviated in the figure which heats the ink stored inside the head unit 24, and the ink heater works under the control of the CPU 41 and heats the ink to the temperature which becomes sol-like. The recording head 242 discharges the ink which became sol-like by heating. When this sol-like ink is discharged on the recording medium P and after the ink droplet lands on the recording medium P, the ink promptly becomes gel-liked and congeals on the recording medium P by being naturally cooled.

The fixer 25 includes an energy ray irradiator arranged throughout the width of the X direction of the conveyer 21, and emits the energy ray such as the ultraviolet ray to the recording medium P mounted on the conveyer 21 from the energy ray irradiator to harden and fix the ink discharged on the recording medium P. The energy ray irradiator of the fixer 25 is arranged between the arrangement position of the head unit 24 with respect to the conveyance direction, and the arrangement position of the delivery drum 261 of the delivery section 26, facing the conveyance surface.

The delivery section 26 includes the belt loop 262 which includes a ring-like belt supported by two rollers inside and the cylinder-like delivery drum 261 which delivers the recording medium P from the conveyer 21 to the belt loop 262, and the recording medium P which was delivered from the conveyer 21 to the belt loop 262 by the delivery drum 261 is conveyed by the belt loop 262 and sent to the medium ejector 30.

When the front and back surfaces of the recording medium P is being reversed, the reverser 27 works under the control of the CPU 41 and reverses the front and back surfaces of the recording medium P delivered from the delivery drum 261, and delivers it to the conveyance drum 211 and mounts on the conveyance surface of the conveyance drum 211. The reverser 27 includes the first drum 271, the second drum 272, and the belt loop 273.

In the reverser 27, the recording medium P is delivered from the clockwise rotating delivery drum 261 of the FIG. 1 to the anti-clockwise rotating delivery drum 271 of the FIG. 1, then delivered to the second drum 272 which rotates in the clockwise direction of the FIG. 1, and then delivered to the belt loop 273 which rotates in the anti-clockwise direction, in order. When the rear end of the recording medium P reaches in the vicinity of the nip part of the second drum 272 and the belt loop 273, the rotation direction of the belt loop 273 changes to the clockwise direction of the FIG. 1, and the recording medium P will be mounted on the conveyance surface of the conveyance drum 211 in the upstream side of the conveyance direction of the delivery drum 222. The recording medium P mounted on the conveyance surface by the reverser 27 is held again at the conveyance drum 211 in the state which the image-formed surface is in contact with the conveyance surface.

Further, the configuration of the reverser 27 is not limited to that of above, and could be selected appropriately among various configurations in which the front and the back surfaces of the recording medium P can be reversed and delivered to the conveyance drum 211.

The medium ejector 30 includes a plate-like paper output tray 31 on which the recording medium P sent from the image former 20 by the delivery section 26 is mounted.

FIG. 2 is a block figure showing the main function configuration of the inkjet recording device 1.

The inkjet recording device 1 includes the heater 23, the head unit 24 including the recording head driver 241 and the recording head 242, the fixer 25, the controller 40, the conveyance driver 51, the operation display 52 (input means), the input/output interface 53, the bus 54, and the like.

The recording head driver 241 discharges the volume of ink according to the pixel value of the image data from the nozzle of the recording head 242, by supplying the driving signal to the recording element of the recording head 242 at an appropriate timing, the driving signal deforming the piezoelectric element according to the image data.

The controller 40 includes the CPU 41 (Central Processing Unit) (image-forming control means, adjustment means), RAM 42 (Random Access Memory), ROM 43 (Read Only Memory) and the storage 44.

CPU 41 reads various programs for controlling and the setting data stored in the ROM 43, stores in the RAM 42, and performs various processing operation by performing the program. Further, the CPU 41 integrally controls the whole operation of the inkjet recording device 1. For example, CPU 41 operates each part of the image former 20 and respectively forms an image on the front surface and the back surface of the recording medium P. Further, the CPU41 performs the set up according to the adjustment of the image which is formed by the recording operation of the head unit 24.

RAM 42 provides the CPU41 with a memory space for working, and stores the temporary data. RAM 42 may include a non-volatile memory.

ROM 43 stores various programs for controlling, the setting data and the like performed by the CPU 41. Further, instead of the ROM 43, a non-volatile memory which is possible to edit, such as an EEPROM (Electrically Erasable Programmable Read Only Memory) and a flash memory could be used.

In the storage 44, the print job (image recording order) and the image data of a normal image which are the forming target according to the print job which were input by the external device 2 through the input/output interface 53, the corrected image data which was earned by correcting the image data by a method described below, and the image data of the scale image and the reference marker used for detecting the positional misalignment from the proper arrangement of the arrangement of the image-forming region which is described below, and the like are stored. As for the storage 44, for example, HDD (hard Disk Drive) could be used and further, DRAM (Dynamic Random Access Memory) could be used together.

The conveyance driver 51 rotates the conveyance drum 211 at a predetermined speed and timing by supplying the drive signal to the conveyance drum motor of the conveyance drum 211 based on the control signal supplied from the CPU 41. Further, the conveyance driver 51 supplies the driving signal to the motor to operate the medium supplier 12, the delivery unit 22, and the delivery section 26 based on the control signal supplied from the CPU 41, to perform the supply of the recording medium P to the conveyer 21 and an ejection from the conveyer 21. Further, the conveyance driver 51 operates the first drum 271, the second drum 272, and the belt loop 273 of the reverser 27 based on the control signal supplied from the CPU 41, and reverses the front and the back surfaces of the recording medium P by the reverser 27.

The operation display 52 includes the display device such as the liquid crystal display and the organic EL display, operation key, and the input device such as the touch panel and ten-key arranged on the screen of the display device by layer. The operation display 52 displays various information on the display device, and outputs in the controller 40 the input operation made by the user to the input device by transforming to an operation signal.

The input/output interface 53 mediates the transmission reception of the data between the external device 2 and the controller 40. The input/output interface 53 is configured by any of various serial interface and various parallel interface or by the combination of these, for example.

The bus 54 is a route to perform the transmission reception of the signal between the controller 40 and the other configurations.

The external device 2 is a personal computer for example, and supplies the print job, the image data and the like to the controller 40 through the input/output interface 53.

Next, the adjustment method of the image-forming region on the recording medium P upon the inkjet recording device 1 of the embodiment is described.

In the inkjet recording device 1 of the embodiment, after the first normal image which is the forming target is formed on the front surface of the recording medium P, the reverser 27 is made to reverse the front and the back surfaces of the recording medium P, and the second normal image which is the forming target could be formed on the back surface of the recording medium P. The formation of the image to both the front and the back surfaces are performed by discharging the ink onto the recording medium P from the head unit 24 according to the image data corresponding respectively to the normal image, and by fixing the ink by the fixer 25.

In the fixing of the ink by the fixer 25, the ink becomes heated by the energy given to the ink, and due to this heat the ink shrinks. As a result, by especially the portion of the recording medium P which the ink was given to shrinking, and the recording medium P deforms from the state in which the image is not yet formed.

Here, the deformation amount of the recording medium P changes according to the amount and the distribution of the ink given to the recording medium P. For example, in the region in the recording medium P where the given ink amount was relatively large, the deformation amount tends to be larger compared to the region where given amount of ink was lesser than the region where the given ink amount was relatively large. Therefore, the deformation amount of the recording medium P changes due to the content of the normal image formed on the recording medium P.

Therefore, when the second normal image is formed on the back surface of the recording medium P after the first normal image was formed on the front surface of the recording medium P, at the time of forming the second normal image, the recording medium P is deformed according to the content of the first normal image, and occurs an unintended positional misalignment of the image-forming region on the front and back surfaces of the recording medium P.

Since then, the inkjet recording device 1 of the embodiment detects the deformation amount of the recording medium P when the first normal image is formed on the front surface of the recording medium P using one sheet of recording medium P. Further, according to the detected deformation amount, the image data according to the second normal image will be corrected so that the first image-forming region on which the first normal image is recorded and the second image-forming region on which the second normal image is formed will be on the same range in both surfaces of the recording medium P. Then, by using the corrected image data on another recording medium P and performing the formation of the adjusted first normal image and the second normal image, the occurrence of the positional misalignment of the first and the second image-forming regions on the front and the back surfaces of the recording medium P could be suppressed.

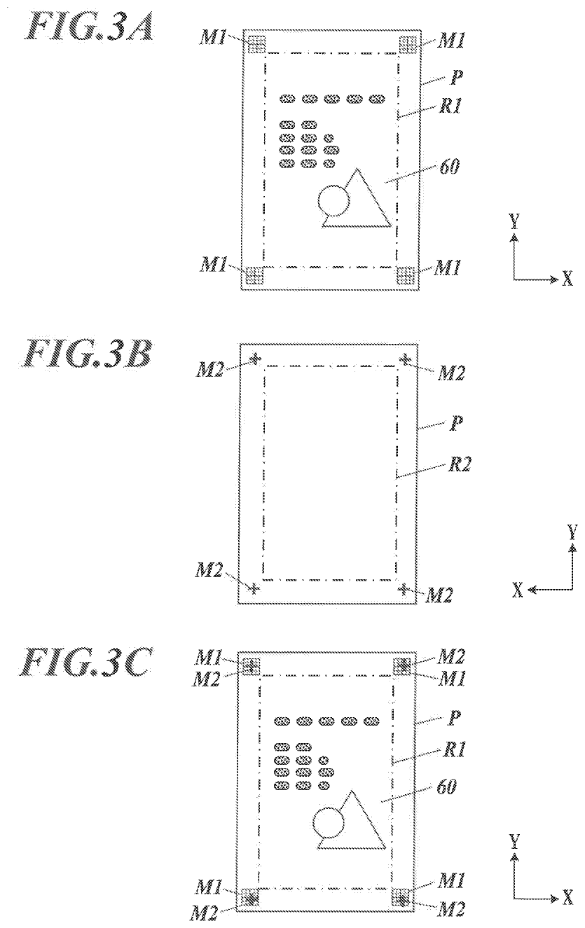

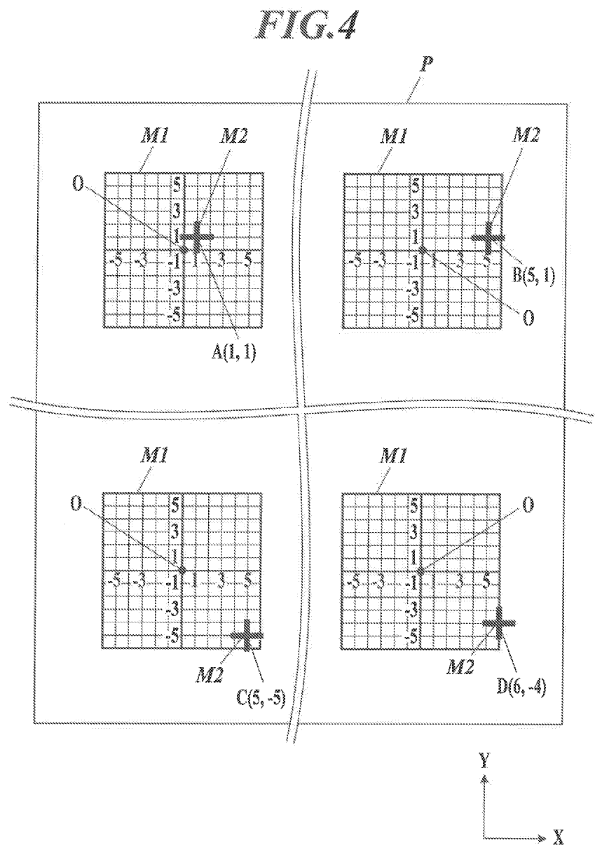

Within the detection of the deformation amount of the recording medium P, first by using one sheet of recording medium P, on the front surface of the recording medium P, together with the first normal image, a predetermined scale image M1 (the first reference mark) (FIG. 3) is formed together in the vicinity of each of the four vertexes in the rectangular recording medium P. Next, the front and the hack surfaces of the recording medium P are reversed, and a cross-shaped reference marker M2 (the second reference mark) (FIG. 3) is formed in the range which is in the vicinity of each of the four vertex in the back surface of the recording medium P and at least one portion of which overlaps the formation range of the scale image M1. And, based on the relative position of the scale image M and the reference marker M2 which are in the vicinity of the each vertex of the recording medium P, the deformation amount of the recording medium P is detected.

FIG. 3 is a figure showing an example of the scale image M and the reference marker M2 formed on the recording medium P.

FIGS. 3A to 3C show a recording medium P which a scale image M1 and the normal image 60 are formed on the front surface and the reference marker M2 is formed on the back surface.

FIG. 3A shows the front surface of the recording medium P, where the first image-forming region on which the normal image 60 is formed, and the scale image M1 which is formed in the vicinity of each of the four vertexes of the recording medium P outside the range of the first image-forming region R1, are shown.

Further, FIG. 3B shows the back surface of the recording medium P, where the reference marker M2 which is formed in the vicinity of each of the four vertexes of the recording medium P outside the range of the second image-forming region R2 which the second normal image is formed on the back surface, is shown.

Further, FIG. 3C is a figure showing the state of the recording medium P observed from the front surface side to be able to see through the reference marker M2 on the back surface, that is, from the direction perpendicular to the surface of the recording medium P. As shown in FIG. 3C, in the vicinity of each of the four vertexes of the recording medium P, the scale image M1 and the reference marker M2 corresponding with the scale image M1 overlap with each other (below, the combination of the corresponding scale image M1 and the reference marker M2 will also be written as the reference mark pair). In order to see through the reference marker M2 on the back surface, it is sufficient to observe the recording medium P by holding it to the lighting and the sunlight, for example.

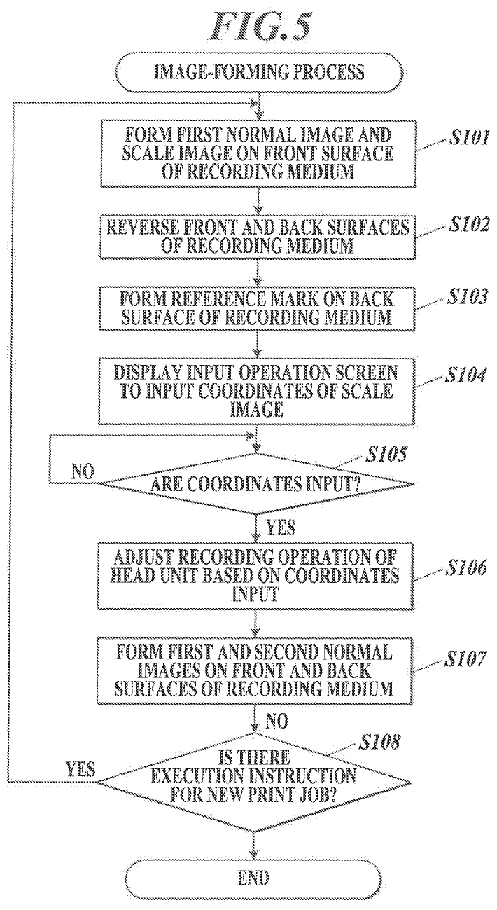

FIG. 4 is a figure showing the enlarged vicinity of each of the vertex of the recording medium P in FIG. 3C.

The scale image M1 includes the scale showing the coordinates which are based on the criterion point O in the range of relative position which is set up in advance against the first image-forming region R1. That is, the scale image M1 shows the coordinate of the Y direction by the scale which is made by plurality of lines extending in the X direction showing the position of the Y direction on the recording medium P, and shows the coordinate of the X direction which is made by plurality of lines extending in the Y direction showing the position of the X direction on the recording medium P. Further, in the vicinity of the coordinate axis of the scale image M1 which is the line running through the criterion point O, the scale value of the scale (numerals showing each component of the coordinates shown by the scale) is shown.

Further, the reference marker M2 is a sign in the form of intersecting two lines, which respectively extend in X direction and Y direction. The two lines configure an indicator which shows the scale at the point of intersection. The reference marker M2 is formed in the predetermined relative position in relation to the second image-forming region, and further, the position which the indicator shows is formed in the range of the relative position set up in advance relating with the scale of the scale image M1, when seen from the perpendicular direction to the surface of the recording medium P. In the embodiment, the reference marker M2 is formed overlapping with at least one portion of the forming region of the scale image M1. The reference marker M2 is formed in the position which indicates the criterion point O of the scale image M1 when seen from the front surface of the recording medium P, in the case where the reference marker M2 is arranged in the proper arrangement fulfilling the predetermined arrangement term for the first image-forming region R1 and the second image-forming region R2 upon both surfaces of the recording medium P, that is, when the normal image is formed on the first image-forming region R1 and the second image-forming region R2 with the original set up for the normal image of the formation target. In the embodiment, the arrangement term are the first image-forming region R1 and the second image-forming region R2 being on the same range on both surfaces of the recording medium P. Therefore, the reference marker M2 shows the scale corresponding to the positional misalignment of the scale image M1 if the first image-forming region R1 and the second image-forming region R2 occurs the positional misalignment when seen from the perpendicular direction to the recording medium P, that is when the arrangement of the first image-forming region R1 and the second image-forming region R2 are moved from the proper arrangement.

In FIG. 4, the reference marker M2 is formed in the position showing the coordinates different from the criterion point O of the scale image M1 based on the deformation of the recording medium P which is made by forming the first normal image 60 on the surface of the recording medium P. That is, in the vicinity of the upper-left vertex of the recording medium P of FIG. 4, the reference marker M2 is formed in the position showing the coordinates A(1,1) on the scale image M1, in the vicinity of the upper-right vertex of the recording medium P, the reference marker M2 is formed in the position showing the coordinates B(5,1) on the scale image M1, in the vicinity of the downer-left vertex of the recording medium P, the reference marker M2 is formed in the position showing the coordinates C(5,−5) on the scale image M1, in the vicinity of the downer-right vertex of the recording medium P, the reference marker M2 is formed in the position showing the coordinates D(6,−4) on the scale image M1.

From these four coordinates A to D, the deformation direction and the deformation amount of the recording medium P could be obtained. From this, the deformation state of the recording medium P could be specified.

Further, in the inkjet recording device 1 of the embodiment, the set up relating to the adjustment of the recording operation by the head unit 24 is made, so that the first image-forming region R1 and the second image-forming region R2 will be on the same range on both surfaces of the recording medium P, and the first and the second normal images are formed on the recording medium P which differs from the recording medium P on which the scale image M1 and the reference marker M2 are formed, based on the four coordinates A to D. The adjustment of the recording operation is made by correcting the image data of the second normal image and by forming the second normal image based on the corrected image data, for example.

The correction of the image data of the second normal image, for example, is made as shown below.

First, in the first step, among the four reference mark pairs which are respectively made by the combination of the scale image M1 and the reference marker M2, for one of the reference mark pairs including the scale image M1 closest to the formation starting position of the first normal image in the first image-forming region R1, there is obtained the required amount of parallel movement of the second normal image to make the difference between the coordinates indicated by the reference marker M2 and the coordinates of the criterion point O (that is, (0,0)) zero. In FIG. 4, the scale image M1 on the downstream side of the conveyance direction, that is either the upper-left or the upper-right corresponds to the scale image M1 closest to the formation starting position of the first normal image. Here, the reference mark pair including the upper-left scale image M1 is on focus. In order for the difference between the coordinates A (1,1) which are shown by the reference marker M2 in the upper-left scale image M1 and the coordinates of the criterion point O to become zero, the required amount of parallel movement of the second normal image is −1 in the X direction and −1 in the Y direction on FIG. 4.

In the next second step, the deformation amount of the second normal image required for making the difference between the coordinates shown by the reference marker M2 and the coordinates of the criterion point O for the remaining three reference mark pairs zero, is obtained.

That is, when the second normal image is parallel moved −1 in the X direction and −1 in the Y direction in FIG. 4 as above written, the coordinates indicated by the reference marker M2 in the scale image M1 of the three reference mark pairs of the upper-right, downer-left, and downer-right of the recording medium P respectively are coordinates Bm (4, 0), coordinates Cm (4, −6), and coordinates Din (5, −5). Therefore, the deformation amount of the second normal image which makes the differences between the coordinates Bin to Dm and the coordinates of the criterion point O zero, is obtained. As for the deformation of the second normal image which could be applied here, the expansion, the minimization, the movement, and the rotation of the image in the X direction and the Y direction are given. For the expansion, the minimization, and the movement, the expansion rate, the minimization rate, and the movement amount could be differed according to the position of the X direction and the Y direction of the image. That is, the deformation which makes the second normal image trapezoid-form or a parallelogram-form could be made.

Then, the image data corresponding to the second normal image is corrected so as the parallel movement in the first step and the deformation in the second step will be reflected.

After the first normal image is formed onto the surface of the recording medium P, and by forming the second normal image on the back surface of the recording medium P using the image data corrected as above, the first normal image and the second normal image will respectively be formed on the front surface and the back surface of the recording medium P, in the mode where the first image-forming region R1 and the second image-forming region R2 overlap in both surfaces of the recording medium P.

These correcting operations of the image are performed in the opportunity when the values of the coordinates A to D are input into the operation display 52 by the operator of the inkjet recording device 1. Therefore, the operator is able to make the inkjet recording device 1 perform image formation matching the image-forming region on the front and the back surfaces of the recording medium P, by a simple work such as seeing through the recording medium P on which the scale image M1 and the reference marker M2 are formed, checking the coordinates A to D which could be read from the position of the scale shown by the indicator of the reference marker M2, and inputting the value to the operation display 25.

Further, the coordinates A to D could be read and be input by the smaller unit than the smallest unit of the scale of the scale image M1.

Above, an example of adjusting the recording operation of the head unit 24 by correcting the image data of the second normal image had been used for describing, however instead, the image data of the first normal image could be corrected. Further, the recording operation could be adjusted by correcting both image data of the first normal image and the image data of the second normal image. Further, the expansion and the minimization of the image in the Y direction could be adjusted by the recording operation correcting the ink discharge timing by each nozzles of the head unit 24.

Next, the control order by the CPU 41 for the image-forming process performed by the inkjet recording device 1 is described.

FIG. 5 is a flowchart showing the control order of the image-forming process.

This image-forming process is performed when the print job and the image data are input to the controller 40 from the external device 2 through the input/output interface 53.

Preceded in the start of the image-forming process, the CPU 41 causes the conveyance driver 51 to output a driving signal to the conveyance drum motor of the conveyance drum 211 and starts the rotating operation of the conveyance drum 211.

When the image-forming process begins, the CPU 41 forms the first normal image and the scale image M1 on the surface of the recording medium P by the head unit 24 (step S101: reference mark forming step). That is, by supplying the image data of the first normal image and the image data of the scale image M1 stored in the storage 44, to the recording head 242 from the recording head driver 241 at an appropriate timing in relation to the rotation of the conveyance drum 211, the CPU 41 forms the first normal image on the surface of the recording medium P by discharging the ink on to the recording medium P from the head unit 24, and forms the scale image M1 in the vicinity of each of the four vertexes of the recording medium P. Further, at the timing when the recording medium P to which the ink is given is moved to the position of the fixer 25, the CPU 41 fixes the ink on the recording medium P by emitting the predetermined energy ray to the ink by the fixer 25.

The CPU 41 reverses the front and the back surfaces of the recording medium P by the reverser 27 (step S102). That is, the CPU 41 outputs the control signal to the conveyance driver 51, to reverse, with the reverser 27, the front and the back surfaces of the recording medium P which has the first normal image and the scale image M1 formed on the front surface and mount the recording medium P onto the conveyance surface of the conveyance drum 211.

The CPU 41 causes the head unit 24 to form the reference marker M2 on the back surface of the recording medium P by the head unit 24 (step S103: reference mark forming step). That is, by supplying the image data of the reference marker M2 stored in the storage 44 from the recording head driver 241 to the recording head 242 at an appropriate timing according to the rotation of the conveyance drum 211, the CPU 41 causes the head unit 24 to discharge the ink to the recording medium P and forms the reference marker M2 in the vicinity of each of the four vertexes on the back surface of the recording medium P. Further, at the timing when the recording medium P which the ink is given to is moved to the position of the fixer 25, the CPU 41 causes the fixer 25 to emit the predetermined energy ray to the ink and fixes the ink on to the recording medium P. Further, the CPU 41 outputs the control signal to the conveyance driver 51 and causes the recording medium P on which the reference marker M2 is formed to be conveyed to the paper output tray 31 of the ejector 30.

Here, the operator of the inkjet recording device 1 observes the recording medium P conveyed to the paper output tray 31 by holing it to the light, and checks the coordinates which the four reference marks M2 show.

The CPU 41 displays the input operation screen, by the operation display 52, relating to the input operation of the input of the coordinates of the scale of the scale image M1 which are respectively shown by the four reference markers M2 (step S104: input step). The input operation screen and the mode of the input operation made correspondingly to the input operation screen are not particularly limited, however for example, it is possible to be in a mode where the image of the ten-key is displayed on the screen of the display device and input the four coordinates by detecting the contact with the portion corresponding to the ten-key on the touch panel. Or, it could be in a mode selecting the value of the coordinates from the plurality of candidates which were set in advance.

The CPU 41 determines whether the input operation of coordinates input to the operation display 52 had been made or not (step s105). If it is determined that the input operation had not been made (“NO” in the step S105), the CPU 41 performs the process of the step S105 again.

If it is determined that the input operation of coordinates input had been made (“YES” in the step S105), the CPU 41 performs the set up relating to the adjustment of the recording operation of the head unit 24 based on the coordinate input (step S106:adjustment step). That is, so that the positional misalignment between the first image-forming region and the second image-forming region which are shown by the coordinates input will be suppressed, the CPU 41 performs the set up for the correction of the image data of the first normal image and/or the image data of the second normal image by the method written above, and the set up for the correction of the ink discharge timing by the head unit 24.

The CPU 41 forms the first normal image on a surface of a new recording medium P by the head unit 24, then reverses the recording medium P by the reverser 27, and forms the second normal image on the back surface of the recording medium P by the head unit 24 (step S107:normal image forming step). Here, when the image data is corrected in the step S106, the CPU 41 forms an image using the corrected image data. Further, if the ink discharge timing in the formation timing of the first normal image and/or the second normal image had been changed in step S106, the CPU 41 forms an image by discharging the ink by the head unit 24 with the corrected timing. As for other points, it is same as the processes of steps S101 to S103.

The CPU 41 determines whether there is (obtained) a new execution instruction of a print job or not (step S108). If it is determined as obtained (“YES” in the step S108), the CPU 41 moves the process to step S101.

If it is determined as the new print job is not obtained (“NO” in the step S108), the CPU 41 ends the image-forming process.

### Modification Example

Next, the modification example of the embodiment will be described. The present modification example is different from the above embodiment in the configuration of the scale image M1 and reference marker M2. Below, the difference from the above embodiment will be described.

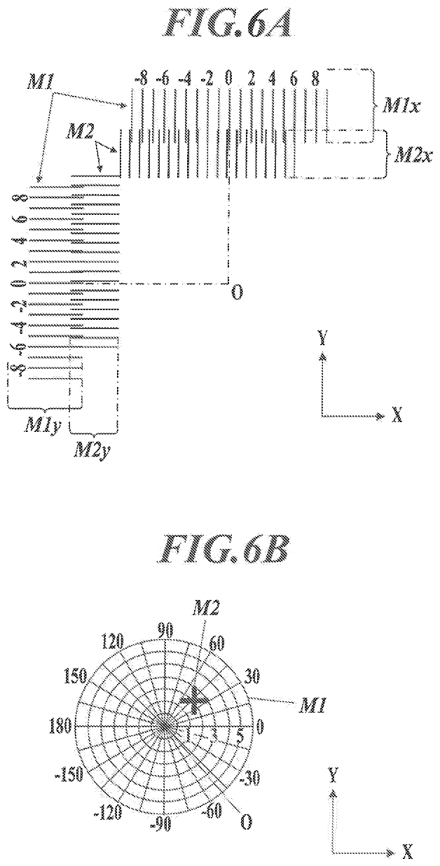

FIG. 6 is a figure showing the example of the scale image M1 and the reference marker M2 according to the modification example.

The scale image M1 shown in FIG. 6A is made of scale Mix which is formed by plurality of lines extending in the Y direction arrayed with an equal interval in X direction and showing the coordinate in X direction, and scale M1y which is formed by plurality of lines extending in the X direction arrayed with an equal interval in Y direction and showing the coordinate in Y direction. Therefore, the range of coordinates shown by the scale of the scale image M1 is the range in a rectangular-form, for which the range in X direction is prescribed by the forming range in the X direction in the scale M1x, and the range in Y direction is prescribed by the forming range in the Y direction in the scale M1y. Further, in the vicinity of the scale Mix and scale M1y, the scale value of the scale is respectively shown. In the scale image of FIG. 6A, the intersection of the respective extending lines which indicate “0” in the scale Mix and the scale M1y becomes the criterion point O.

Further, the reference marker M2 is made by the indicating scale M2x which is formed by plurality of lines extending in the Y direction arrayed with an equal interval in X direction, and the indicating scale M2y which is formed by plurality of lines extending in the X direction arrayed with an equal interval in Y direction. Here, the arrangement interval of each line of the indicating scale M2x is slightly smaller than the arrangement interval of each line of the scale M1x, and also the arrangement interval of each line of the indicating scale M2y is slightly smaller than the arrangement interval of each line of the scale M y.

Further, the reference marker M2 is formed in the position where any one of the indicating scale M2x matches with the line showing the origin of the scale M1x, and any one of the indicating scale M2y matches with the line showing the origin of the scale M1y, when the first image-forming region R1 and the second image-forming region R2 are in the same range on both surfaces of the recording medium P.

According to these scale image M1 and reference marker M2, the misalignment of the X direction between the first image-forming region R1 and the second image-forming region R2 in the position in the scale image M1 is shown by the position of the line which matches with any of the lines in the indicating scale M2x in each line of the scale M1x. Further, the misalignment of the Y direction between the first image-forming region R1 and the second image-forming region R2 in the position in the scale image M1 is shown by the position of the line which matches with any of the lines in the indicating scale M2y in each lines of the scale M1y. In FIG. 6A, the “−2” line of the scale M1x matches with one of the lines of the indicating scale M2x, and the “2” line of the scale M1y matches with one of the lines of the indicating scale M2y. Therefore, the operator of the inkjet recording device 1 inputs the coordinates of “−2” and “2” to the operation display 52 so as to cause the inkjet recording device 1 to perform the image-forming in which the image-forming region on the front and the back surfaces of the recording medium P matches.

The scale image M1 shown in FIG. 6B is made of a line extending radially in equal intervals passing through the criterion point O, and a line in concentric circles in equal intervals placing the criterion point O as for the center. Further, in the vicinity of the criterion line extending in the X direction in the radial lines, the scale value showing the distance from the origin is shown. Further, in the vicinity of the most outer line in the concentric line, the scale value showing the rotation angle from the criterion line which places the criterion point O as for the center, is shown.

Further, the reference marker M2 is in a cross-shape form as like in the above embodiment.

According to such scale image M1 and the reference marker M2, the position in the scale image M1 could be specified by the circular coordinates (the polar coordinates on the two dimension space). From this, the deformation direction and the deformation amount of the recording medium P in the position of each of the scale image M could be easily specified.

As shown above, the inkjet recording device 1 according to the embodiment provides the head unit 24 performing the recording operation giving an ink to the recording medium P which is possible to allow a portion of the incident light to penetrate, the operation display 52 which accepts the input operation from external, and the CPU 41, where the CPU 41 performs the set up according to the adjustment of the image formed by the recording operation of the head unit 24 (adjustment means), causes the head unit 24 to perform the recording operation, makes to form an image on the front surface and the back surface of the recording medium P respectively, causes the head unit 24 to form the scale image M1 on the surface of the first recording medium P, causes the head unit 24 to form the reference marker M2 on the back surface of the first recording medium P (image-forming control means), and the scale image M1 includes the scale showing the coordinates according to the relative positon in the range of the relative position which was determined in advance against the first image-forming region R1 on the front surface where a normal image which is the formation target to be formed, and the reference marker M2 includes the indicator which shows the predetermined relative position against the second image-forming region R2 where a normal image is to be formed on the back surface of the recording medium P and the reference marker M2 is formed so that the position indicated by the indicator is located in the range of the relative position determined in advance according to the scale of the scale image M1 when seen from the perpendicular direction to the front surface of the first recording medium P, the operation display 52 accepts the input operation of the coordinates read from the scale in the position shown by the indicator, and the CPU 41 performs the set up according to the adjustment of the recording operation by the head unit 24 so as to reduce the positional misalignment of the first image-forming region R1 and the second image-forming region R2 on both surfaces of the recording medium P based on the coordinates input (adjustment means), and forms the normal image adjusted respectively on the front surface and the back surface of the second recording medium P which differs from the first recording medium P by the head unit 24 based on the set up according to the adjustment (image-forming control means).

According to such configurations, the operator of the inkjet recording device 1 reads the coordinates of the scale of the scale image M1 shown by the reference marker M2 by seeing through the recording medium P, and by a simple work of coordinates input to the operation display 52, it is possible to form a normal image by making the adjustment of the recording operation by the head unit 24 so the positional misalignment between the image-forming region on the front and the back surfaces of the recording medium reduces. Further, since there is no need for the operator to input the direction according to the adjustment of the image-forming region, it is possible to suppress the occurrence of the malfunction due to the mistake in the direction. Further, there is no need to provide a reading means to read the scale image M and the reference marker M2, it is possible to realize simplicity of the configuration and make the cost low for the inkjet recording device 1. As like this, according to the inkjet recording device 1 in the embodiment, it is possible to easily and appropriately suppress the positional misalignment of the image-forming region in the front and the back surfaces of the recording medium P by a simple configuration.

Further, at least on the surface on which the image is to be formed earlier among the front and back surfaces of the first recording medium P, the CPU 41 forms either one of the scale image M1 and the reference marker M2, and the normal image (image-forming control means). Due to this, it is possible to suppress the positional misalignment of the image-forming region on the front and the back surfaces of the recording medium P based on the shrinking of the recording medium P by the formation of the normal image.

Further, by correcting at least either one of the image data according to the first normal image formed on the front surface of the second recording medium P, and the image data according to the second normal image formed on the back surface of the second recording medium P, the CPU 41 performs the set up according to the adjustment of the recording operation (adjustment means). Due to this, even if the positional misalignment of the image-forming region on the front and the back surfaces of the recording medium P are under a complicated mode according to the expansion, the minimization, and the movement of the conveyance direction and the width direction, and the combination of these and the rotation, it is possible to suppress the positional misalignment appropriately.

Further, the inkjet recording device 1 includes, the conveyer 21 which relatively moves the head unit 24 and the recording medium P in the conveyance direction, and the CPU 41 causes the head unit 24 to form the normal image, the scale image M1 and the reference marker M2 on the recording medium P which is relatively moving (image-forming control means), and performs the set up according to the adjustment of the recording operation of the conveyance direction by correcting the timing of giving the ink to the recording medium P by the head unit 24 (adjustment means). Due to this, it is possible to suppress the positional misalignment of the conveyance direction of the image-forming region on the front and the back surfaces of the recording medium P easily.

Further, the CPU 41 causes the head unit 24 to form the normal image, the scale image M1 and the reference marker M2 on the recording medium P which is relatively moving (image-forming control means), and each of the component of the coordinates shown by the scale respectively shows the position of the conveyance direction in the first recording medium P, and the position of the width direction which is at right angles to the conveyance direction. Due to this, it is possible to specify the direction and the size of the positional misalignment of the image-forming region on the front and the back surfaces of the recording medium P by the orthogonal coordinate system, and shows the operator the positional misalignment easily.

Further, the CPU 41 causes the head unit 24 to at least form the scale image M1 and the reference marker M2 in the vicinity of each of the opposite vertexes of a pair on the first recording medium P which is rectangular (image-forming control means). Due to this, it is possible to specify the direction and the size in the width direction and the conveyance direction of the positional misalignment in the image-forming region on the front and the back surfaces of the recording medium P.

Further, the CPU 41 causes the head unit 24 to form the scale image M1 and the reference marker M2 in the vicinity of each of the four vertexes of the first recording medium P (image-forming control means). Due to this, the positional misalignment could be suppressed appropriately even if the positional misalignment of the image-forming region on the front and the back surfaces of the recording medium P is not equal in the width direction and the conveyance direction and even if the positional misalignment includes a rotation.

Further, when formation of the normal image on the first image-forming region R1 and the second image-forming region R2 is done by the original set up for the normal image of the forming target against the first recording medium P1, the reference marker M2 is formed in the position where the indicator shows the coordinates of the criterion point O of the scale image M1 when it is seen from the perpendicular direction to the front surface of the first recording medium P1, and the CPU 41 performs the set up according to the adjustment of the recording operation based on the difference between the coordinates input to the operation display 52 and the coordinates of the criterion point O (adjustment means). Due to these configurations, by confirming whether or not the indicator of the reference marker M2 is showing the criterion point O when the recording medium is seen through, it is able to easily determine whether or not the normal image is formed on the first image-forming region R1 and the second image-forming region R2 as set up.

Further, the CPU 41 forms four scale images M on the front surface of the first recording medium P by the head unit 24, forms four reference marks M2 corresponding to the four scale images M 1 on the back surface of the first recording medium P (image-forming control means), and performs the setting up relating to adjustment to adjust the difference according to one predetermined reference mark pair among the four reference mark pairs to zero by parallel moving at least either one of the first image-forming region and the second image-forming region based on four differences according to the four reference mark pairs each of which is made by a combination of the scale image M1 formed on the first recording medium P and the reference marker M2 corresponding to the scale image M1, and to adjust the difference of the reference mark pairs other than the one predetermined reference mark pair to zero by deforming at least one of the first image-forming region R1 and the second image-forming region R2 (adjustment means). Due to this, an adjustment of the recording operation could be done with an easy process.

Further, the predetermined one reference mark pair is selected from the reference mark pair including the scale image M1 which is closest to the formation starting position of the normal image in either one of the first image-forming region R1 and the second image-forming region R2, where the normal image is formed earlier in the second recording medium P. Due to this, it is possible to adjust the positional misalignment of the image-forming region by making the formation starting positon of the normal image in the second recording medium P as a basis.

Further, the scale image M1 includes the scale value of the scale. Due to this, the value of the coordinates shown by the scale could easily be shown to the operator.

Further, the image-forming method in the embodiment includes a reference mark forming step of causing the head unit 24 to form the scale image M1 on the front surface of a first recording medium, and causing the head unit 24 to form a reference marker M2 on the back surface of the first recording medium P wherein the scale image M1 includes a scale indicating a coordinate corresponding to a relative position in a range of the relative position which is determined in advance in relation to a first image-forming region R1 where a normal image which is a formation target is formed on the front surface, the reference marker M2 includes an indicator indicating a predetermined relative position in relation to a second image-forming region R2 where the normal image is formed on the back surface of the recording medium P, and the reference marker M2 is formed so that the position indicated by the indicator is in the image of the relative position which is determined in advance according to the scale of the scale image M1 when the reference marker M2 is seen from a perpendicular direction to the front surface of the first recording medium P, and the image-forming method includes: an input step of accepting, with the operation display 52, an input operation of a coordinate of the scale in the position indicated by the indicator, an adjustment step of performing a setting up for an adjustment of the recording operation by the recording means so as to reduce a positional misalignment of the first image-forming region and the second image-forming region on both surfaces of a recording medium based on the coordinate input by the input means; and

a normal image forming step of causing the recording means to form each adjusted normal image on the one surface and the other surface of a second recording medium which differs from the first recording medium based on the setting up for the adjustment by the adjustment means. Due to these means, it is possible to easily and appropriately suppress the positional misalignment of the image-forming region on the front and the back surfaces of the recording medium P by an easy configuration.

Further, the present invention is not limited to the above-mentioned embodiment and the each modification example, and able to be changed variously.

For example, in the above-mentioned embodiment and the each modification example, the example of the first normal image and the scale image M1 being formed on the front surface of the recording medium P and the reference marker M2 being formed on the back surface of the recording medium P had been used for describing, however instead, it is sufficient to form only the scale image M1 on the front surface of the recording medium P, to form only the reference marker M2 on the back surface of the recording medium P, and read the scale of the scale image M1 shown by the reference marker M2. Even in the event where the scale image M1 and the reference marker M2 are formed like this, it is possible to suppress the positional misalignment by specifying the positional misalignment of the image-forming region in both surfaces of the recording medium P occurred by the reason other than the deformation of the recording medium P, such as the positional misalignment of the mounting position of the recording medium P at the time of conveying the recording medium P and at the time of reversing the front and the back surfaces, and the positional misalignment of the installing position of the head unit 24.

Further, in the above-mentioned embodiment and the each modification example, the example of forming the scale image M1 on the front surface and forming the reference marker M2 on the back surface of the recording medium P had been used for describing, however, it is sufficient with forming the reference marker M2 on the front surface and forming the scale image M1 on the back surface of the recording medium P.

Further, in the above-mentioned embodiment and the modification example, the example of forming the first normal image and the scale image M1 on the front surface of the recording medium P and forming the reference marker M2 on the back surface of the recording medium P had been used for describing, however instead, it is sufficient with forming the first normal image and the scale image M1 on the front surface of the recording medium P, forming the second normal image and the reference marker M2 on the back surface of the recording medium P, and read the scale of the scale image M1 shown by the reference marker M2.

Further, the first reference mark is not limited to the scale image M1 shown in the above-mentioned embodiment and the modification example, and is sufficient with any kind of sign which includes the scale showing the coordinates on the recording medium P. Further, the second reference mark is not limited to the reference marker M2 shown in the above-mentioned embodiment and the modification example, and is sufficient with any kind of sign which includes the indicator showing the predetermined relative position against the second image-forming region R2.

Further, in the above-mentioned embodiment and the modification example, the example of respectively forming the scale image M1 and the reference marker M2 in the vicinity of each of the four vertexes of the recording medium P had been used for describing, however, the point does not limited to this. When the deformation in the image-forming region in the non-parallel direction with the side of the recording medium P is not apparent, it is possible to appropriately suppress the positional misalignment of the image-forming region in both surfaces of the recording medium P, by forming the scale image M1 and the reference marker M2 at least in the vicinity of the opposite vertexes. It is sufficient with forming the scale image M1 and the reference marker M2 in three points among the four vertexes of the recording medium P, and further, in addition to the vicinity of four vertexes, it could be formed in the optional position except in the vicinity of the vertex. By adding more formation position of the scale image M1 and the reference marker M2, it is possible to more accurately suppress the positional misalignments of the image-forming region on both surfaces of the recording medium P. Further, when the normal image is not formed together with the scale image M1 and the reference marker M2, it is sufficient with forming the scale image M1 and the reference marker M2 in the first image-forming region R1 and the second image-forming region R2.

Further, in the above-mentioned embodiment and the modification example, the example which the criterion point O of the coordinates shown by the scale of the scale image M is the origin (0, 0) of the coordinates had been used for describing, however instead, the coordinates other than the origin could be the criterion point. Further, the coordinates shown by the scale of the scale image M1 could be coordinates which use the point outside the range of the scale image M1 as the origin.

Further, in the above-mentioned embodiment and the modification example, the example of the arrangement condition for making the arrangement of the image-forming region to be at the proper arrangement is the first image-forming region R1 and the second image-forming region R2 being made in the same range in both surfaces of the recording medium P, had been used for describing, however the proper arrangement of the image-forming region and the arrangement condition according to the proper arrangement are not limited to these. For example, when the size of the first image-forming region R1 and the second image-forming region R2 differs, the arrangement in which the predetermined two sides of the rectangle prescribing the first image-forming region R1, and the predetermined two sides of the rectangle prescribing the second image-forming region R2 overlap each other, could be taken as the proper arrangement. In such case, the scale image M1 and the reference marker M2 are formed so as to indicate the criterion point O of the scale image M1 by the reference marker M2 when the image-forming region is in the proper arrangement.

Further, in the above-mentioned embodiment and the modification example, the example of reversing the front and the back surfaces of the recording medium P by the reverser 27 had been used for describing, however the point is not limited to this. For example, without providing the reverser 27 on the inkjet recording medium 1, it is sufficient with the front and the back surfaces of the recording medium P being reversed manually and being mounted on the conveyance surface of the conveyance drum 211.

Further, in the above-mentioned embodiment and the modification example, the example of the inkjet recording device 1 discharging the ink, which is gel-like at the normal temperature and heated to be sol-like, by heating the ink to be sol-like had been used for describing, however the point is not limited to this, and various widely known inks including the ink which is sol-like or liquid in the normal temperature could be used. Therefore, the present invention could be applied to the inkjet recording device which uses the ink fixed on the recording medium P without being fixed by the fixer.

Further, in the above-mentioned embodiment and each of the modification example, the example of the inkjet recording device 1 of the single pass manner had been used for describing, however, the present invention could be applied to an inkjet recording device which records the image by alternately repeating the operation performing the recording of the image by main scanning the head unit in the main scanning direction and the operation moving the recording medium P in the subscanning direction.

Further, in the above-mentioned embodiment and each of the modification example, the example of the inkjet recording device 1 being the piezo manner using the piezoelectric element as for the image-forming apparatus had been used for describing, however it is not limited to this point. For example, the present invention could be applied to image-forming apparatus with various manners such as, the inkjet recording device of the thermal manner which discharges the ink by making air bubble in the ink by heating, an image-forming apparatus of the dry electrophotographic manner which forms the figure of the toner particle (color material) on the photoreceptor drum and transfers the figure onto the recording medium, and an image-forming apparatus of the wet electrophotographic manner which uses the liquid toner instead of the toner particle as for the color material.

Several embodiments of the present invention had been described, however, the range of the present invention is not limited to the embodiment mentioned above, but includes the invention indicated in the scope of claim and the equal scopes.

### INDUSTRIAL APPLICABILITY

The present invention is applicable to the image-forming apparatus and the image-forming method.

### EXPLANATION OF REFERENCE NUMERALS

1 inkjet recording device
2 external device
10 paper supplier
11 paper feeding tray
12 medium supplier
20 image former
21 conveyer
211 conveyance drum
22 delivery unit
23 heater
24 head unit
241 recording head driver
242 recording head
25 fixer
26 delivery section
27 reverser
30 medium ejector
31 paper output tray
40 controller
41 CPU
42 RAM
43 ROM
44 storage
51 conveyance driver
52 operation display
53 input/output interface
54 bus
60 normal image
M1 scale image
M2 reference mark
O criterion point
P recording medium
R1 first image-forming region
R2 second image-forming region

1. An image-forming apparatus comprising:
a recorder to perform recording operation to give a color material to a recording medium which allows a portion of an incident light to penetrate,
a hardware processor that:
causes the recorder to perform the recording operation and form each image on one surface and the other surface opposite to the one surface of the recording medium, and
performs a setting up for adjusting of the image caused to be formed by the recording operation of the recorder by the hardware processor, and
an input section to accept input operation from external, wherein
the hardware processor causes the recorder to form a first reference mark on the one surface of a first recording medium, and causes the recorder to form a second reference mark on the other surface of the first recording medium,
the first reference mark includes a scale indicating a coordinate corresponding to a relative position in a range of the relative position which is determined in advance in relation to a first image-forming region where a normal image which is a formation target is formed on the one surface,
the second reference mark includes an indicator indicating a predetermined relative position in relation to a second image-forming region where the normal image is formed on the other surface, and the second reference mark is formed so that the position indicated by the indicator is in the range of the relative position which is determined in advance according to the scale of the first reference mark when the second reference mark is seen from a perpendicular direction to the one surface of the first recording medium,
the input section accepts an input operation of a coordinate which is read from the scale in the position indicated by the indicator,
the hardware processor performs a setting up for an adjustment of the recording operation by the recorder so as to reduce a positional misalignment of the first image-forming region and the second image-forming region on both surfaces of a recording medium based on the coordinate input by the input section, and
the hardware processor causes the recorder to form each adjusted normal image on the one surface and the other surface of a second recording medium which differs from the first recording medium based on the setting up for the adjustment by the hardware processor.

2. The image-forming apparatus according to claim 1, wherein the hardware processer causes the recorder to form either one of the first reference mark or the second reference mark, and the normal image on at least a surface where an image is formed earlier among the one surface and the other surface of the first recording medium.

3. The image-forming apparatus according to claim 1, wherein the hardware processer performs the setting up for the adjustment of the recording operation by correcting at least either one of image data for a normal image formed on the one surface of the second recording medium and image data for a normal image formed on the other surface of the second recording medium.

4. The image-forming apparatus according to claim 1, comprising a mover to relative move the recorder and a recording medium in a first direction, wherein
the hardware processor causes the recorder to form the normal image, the first reference mark and the second reference mark on the recording medium which relative moves, and
the hardware processor performs a setting up for an adjustment of the recording operation in the first direction by correcting a giving timing of the color material onto the recording medium by the recorder.

5. The image-forming apparatus according to claim 1, comprising a mover to relative move the recorder and a recording medium in a first direction, wherein
the hardware processor causes the recorder to form the normal image, the first reference mark and the second reference mark on the recording medium which relative moves, and
components of a coordinate indicated by the scale respectively indicate a position in the first direction and a position in a second direction which is orthogonal to the first direction on the first recording medium.

6. The image-forming apparatus according to claim 1, wherein the hardware processor at least causes the recorder to form the first reference mark and the second reference mark in vicinity of each of opposite vertexes of a pair on the first recording medium which is rectangular.

7. The image-forming apparatus according to claim 6, wherein the hardware processor causes the recorder to form the first reference mark and the second reference mark in vicinity of each of four vertexes on the first recording medium.

8. The image-forming apparatus according to claim 1, wherein
the second reference mark is formed in a position on the first recording medium where the indicator indicates a coordinate of a predetermined criterion point of the first reference mark when the second reference mark is seen from the perpendicular direction to the one surface of the first recording medium in a case where the normal image of the formation target is formed in the first image-forming region and the second image-forming region of the first recording medium as originally set up, and
the hardware processor performs the setting up for the adjustment of the recording operation based on a difference between the input coordinate and the coordinate of the criterion point.

9. The image-forming apparatus according to claim 8, wherein
the hardware processor causes the recorder to form a plurality of the first reference marks on the one surface of the first recording medium, and form a plurality of the second reference marks corresponding to the plurality of the first reference marks on the other surface of the first recording medium, and
the hardware processor performs the setting up for adjustment to adjust the difference for one predetermined reference mark pair among the plurality of reference mark pairs to zero by parallel moving at least either one of the first image-forming region and the second image-forming region based on a plurality of the differences for the plurality of the reference mark pairs each of which is made by a combination of the first reference mark formed on the first recording medium and the second reference mark corresponding to the first reference mark, and to adjust the difference for the reference mark pair other than the one predetermined reference mark pair to zero by deforming at least one of the first image-forming region and the second image-forming region.

10. The image-forming apparatus according to claim 9, wherein the one predetermined reference mark pair is selected from the reference mark pair including the first reference mark which is closest to a formation starting position of the normal image in either one of the first image-forming region and the second image-forming region, where the normal image is formed earlier on the second recording medium.

11. The image-forming apparatus according to claim 1, wherein the first reference mark includes a scale value of the scale.

12. An image-forming method by an image-forming apparatus that includes: a recorder to perform recording operation to give a color material to a recording medium which allows a portion of an incident light to penetrate; and an input section to accept input operation from external, and that forms each image on one surface and the other surface opposite to the one surface of the recording medium by the recording operation of the recorder and performs a setting up for adjusting of the image caused to be formed by the recording operation of the recorder, and the method comprising:
a reference mark forming step of causing the recorder to form a first reference mark on the one surface of a first recording medium, and causing the recorder to form a second reference mark on the other surface of the first recording medium, wherein
the first reference mark includes a scale indicating a coordinate corresponding to a relative position in a range of the relative position which is determined in advance in relation to a first image-forming region where a normal image which is a formation target is formed on the one surface,
the second reference mark includes an indicator indicating a predetermined relative position in relation to a second image-forming region where the normal image is formed on the other surface, and the second reference mark is formed so that the position indicated by the indicator is in the range of the relative position which is determined in advance according to the scale of the first reference mark when the second reference mark is seen from a perpendicular direction to the one surface of the first recording medium, and
the image-forming method comprises:
an input step of accepting, with the input section, an input operation of a coordinate which is read from the scale in the position indicated by the indicator;
an adjustment step of performing a setting up for an adjustment of the recording operation by the recorder so as to reduce a positional misalignment of the first image-forming region and the second image-forming region on both surfaces of a recording medium based on the coordinate input by the input section; and
a normal image forming step of causing the recorder to form each adjusted normal image on the one surface and the other surface of a second recording medium which differs from the first recording medium based on the setting up for the adjustment by the adjustment step.
